(19) United States
(12) Patent Application Publication
(10) Pub. No.: US 2024/0365103 A1
(43) Pub. Date: Oct. 31, 2024

(54) MULTI-LINK DEVICE (MLD) LEVEL ROAMING AND LINK LEVEL ROAMING IN A WIRELESS NETWORK

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/644,895

(22) Filed: Apr. 24, 2024

Related U.S. Application Data
(60) Provisional application No. 63/498,135, filed on Apr. 25, 2023.

(51) Int. Cl. H04W 8/08; H04W 76/15

(52) U.S. Cl. CPC H04W 8/082; H04W 76/15

(57) ABSTRACT

A non-access point (non-AP) multi-link device (MLD) is arranged to roam within a roaming AP MLD comprising a plurality of AP MLDs. The non-access point MLD receives from the roaming AP MLD an announcement. In an example, the announcement indicates that the roaming AP supports one of a link level roaming and MLD roaming within the roaming AP MLD. Based on the announcement, the non-AP MLD sends a roaming request to the roaming AP MLD, where the roaming request indicates one of the link level roaming and MLD roaming. A roaming response is received from the roaming AP MLD where the response indicates at least one new link established from the non-AP MLD to the roaming AP MLD. Based on the new link which is established, the non-AP MLD exchanges frames with the roaming AP MLD.

### CROSS-REFERENCE TO RELATED APPLICATIONS

This application is entitled to the benefit of U.S. Provisional Patent Application Ser. No. 63/498,135, filed Apr. 25, 2023, the content of which is incorporated herein by reference in its entirety.

### BACKGROUND

A roaming access point (AP) multi-link device (MLD) with distributed AP MLDs at different locations facilitates smooth roaming by a non-AP MLD within an area covered by the AP MLDs. Because the area covered is large, chance of the non-AP MLD transitioning from an AP MLD of one roaming AP MLD to an AP MLD of another roaming AP MLD is reduced. The non-AP MLD sets up links with one AP MLD affiliated with the roaming AP MLD referred to as a single serving AP MLD mode or sets up links with multiple AP MLDs affiliated with the roaming AP MLD referred to as a multiple serving AP MLD mode. In some case, a non-AP MLD's set-up links with two AP MLDs (AP MLD1 and AP MLD2) affiliated with the roaming AP MLD is allowed only during the roaming stage of the non-AP MLD from AP MLD1 (a current serving AP MLD) to AP MLD2 (a target AP MLD). The non-AP MLD performs a link level roaming operation where the non-AP MLD sets up links from a current serving AP MLD affiliated with a roaming AP MLD to the current serving AP MLD and a target AP MLD affiliated with the roaming AP MLD and then from the current serving AP MLD and the target AP MLD affiliated with the roaming AP MLD to the target AP MLD affiliated with the roaming AP MLD. Alternatively, the non-AP MLD performs an MLD level roaming operation when the non-AP MLD sets up links from one AP MLD (the current serving AP MLD) affiliated with a roaming AP MLD to another AP MLD (target AP MLD) affiliated with the roaming AP MLD. When a non-AP MLD roams among the AP MLDs affiliated with the roaming AP MLD, the transition between AP MLDs occurs without a need for reassociation, referred to as smooth roaming, since the non-AP MLD already made an association with the roaming AP MLD through an AP MLD (such as the current serving AP MLD) affiliated with the roaming AP MLD.

### BRIEF DESCRIPTION OF DRAWINGS

FIG. 1 illustrates a multi-link communications system for wireless (e.g., WiFi) communications in accordance with an embodiment.

FIG. 2 is an example of MLD level roaming in accordance with an embodiment.

FIG. 3 is an example of a link level roaming in accordance with an embodiment.

FIG. 4 is another example of a link level roaming in accordance with an embodiment.

FIG. 5 is a flow chart of functions associated with roaming in the multi-link communication system in accordance with an embodiment.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, “an example”, or similar language means that a particular feature, structure, or characteristic described in connection with the indicated embodiment is included in at least one embodiment of the present invention. Thus, the phrases “in one embodiment”, “in an embodiment”, “an example”, and similar language throughout this specification may, but do not necessarily, all refer to the same embodiment.

Embodiments disclosed herein are directed to a non-access point (AP) multi-link device (MLD) roaming among AP MLDs affiliated with a roaming AP MLD at an MLD level or link level. A non-AP MLD sends a roaming request to the roaming AP MLD and the roaming AP MLD sends a roaming response to the non-AP MLD. The roaming request indicates the links to be set up with a target serving AP MLD of the roaming AP MLD and various capabilities of the STA affiliated with the non-AP MLD to which the links are to be set up. In an example, the roaming AP MLD indicates by an announcement from the roaming AP MLD whether it supports link level roaming or MLD roaming. When the support of link level roaming is announced, the MLD level roaming is also supported and a non-AP MLD can select one of the roaming modes to do the roaming. The links to be set up and the roaming is one of a link level roaming or MLD roaming based on this announcement. An AP MLD sends a roaming response to the roaming request. The roaming response indicates whether the roaming request is accepted and, if accepted, the accepted set up link(s). The roaming response also indicates various capabilities of the APs affiliated with a target serving AP MLD in the set up links. Based on the accepted roaming response, the non-AP MLD is able to perform a smooth roaming within the roaming AP MLD where a transition between a current serving AP MLD and the target AP MLD affiliated with the roaming AP MLD occurs without a need for reassociation. Well known instructions, protocols, structures, and techniques have not been shown in detail in order not to obfuscate the description.

Several aspects of the disclosed WiFi system will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

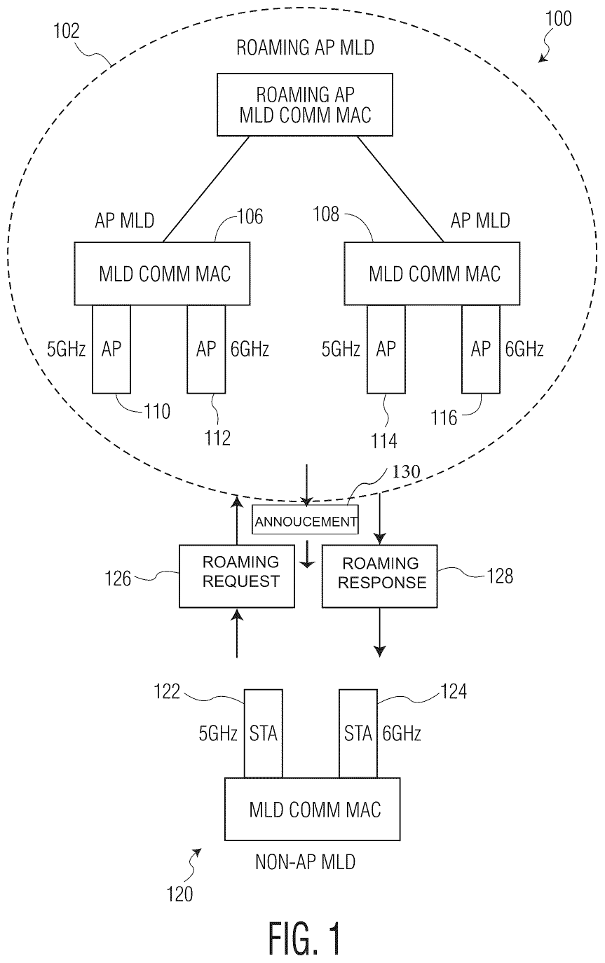

FIG. 1 illustrates a multi-link communications system 100 for wireless (e.g., WiFi) communications in accordance with an embodiment. In the embodiment shown in FIG. 1, the multi-link communications system 100 includes a roaming access point (AP) multi-link device (MLD) 102 which includes a number of different AP MLDs 106, 108 in different physical locations that operate together and each have a common medium access control (MAC) service access point (SAP) address. The multi-link communications system 100 also has a station (STA) MLD (non-AP MLD) 120. The multi-link communications system 100 can be used in various applications, such as industrial applications, medical applications, computer applications, and/or consumer or enterprise applications. In some embodiments, the multi-link communications system 100 may be a wireless communications system, such as a wireless communications system compatible with an IEEE 802.11 protocol. For example, the multi-link communications system 100 may be a wireless communications system compatible with an IEEE 802.11bn protocol and various other iterations of the 802.11 specification are referred to herein including but not limited to IEEE 802.11ac, IEEE 802.11be, and IEEE 802.11ax. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR).

Although the depicted multi-link communications system 100 is shown in FIG. 1 with certain components and described with certain functionality herein, other embodiments of the multi-link communications system 100 may include fewer or more components to implement the same, less, or more functionality. For example, in some embodiments, the multi-link communications system 100 includes multiple associated STA MLDs. In some embodiments, an AP MLD may have a single affiliated AP. In some embodiments, an STA MLD may have a single affiliated STA. In another example, although the multi-link communications system 100 is shown in FIG. 1 as being connected in a certain topology, the network topology of the multi-link communications system is not limited to the shown topology.

The roaming AP MLD 102 has AP MLD 106 and AP MLD 108 which are collectively referred to herein as a distributed AP MLD group. In an example, the distributed AP MLD group may be an extended service set (ESS) or part of an ESS. In some embodiments, upper layer Media Access Control (MAC) functionalities (e.g., association establishment, reordering of frames, etc.) is implemented in a common MAC of an AP MLD and a common MAC of the roaming AP MLD, and the APs of the AP MLD implement lower layer MAC functionalities (e.g., backoff, frame transmission, frame reception, etc.). In an example, AP MLD 106 may have APs 110, 112 and AP MLD 108 may have APs 114, 116. The APs may be implemented in hardware (e.g., circuits), software, firmware, or a combination thereof and fully or partially implemented as an integrated circuit (IC) device. In some embodiments, the APs may be wireless APs compatible with at least one WLAN communications protocol (e.g., at least one IEEE 802.11 protocol). For example, the APs may be wireless APs compatible with the IEEE 802.11bn protocol.

In some embodiments, the roaming AP MLD 102 connects to a local area network (e.g., a LAN) and/or to a backbone network (e.g., the Internet) through a wired connection and wirelessly connects to the non-AP MLD 120, for example, through one or more WLAN communications protocols, such as IEEE 802.11 protocol. In some embodiments, an AP affiliated with an AP MLD includes multiple RF chains. In some embodiments, the AP includes at least one antenna, at least one transceiver operably connected to the at least one antenna, and at least one controller operably connected to the corresponding transceiver. In some embodiments, at least one transceiver is a physical layer (PHY) device. The at least one controller may be configured to control the at least one transceiver to process packets. In some embodiments, the at least one controller may be implemented within a processor, such as a microcontroller, a host processor, a host, a digital signal processor (DSP), or a central processing unit (CPU). In some embodiments, the roaming AP MLD 102 is a logical entity that co-located with the AP MLDs.

In an example, each of the APs may operate in a different basic service set (BSS) operating channel in different bands. The AP may be 5 GHz or 6 GHz. In an example, the AP MLD 106 includes a 5 GHz AP 110 and 6 GHz AP 112. The AP MLD 108 includes a 5 GHz AP 114 and 6 GHz AP 116.

The non-AP STA MLD 120 includes two non-AP STAs 122, 124 which are implemented in hardware (e.g., circuits), software, firmware, or a combination thereof. The STAs 122, 124 may be fully or partially implemented as an IC device. In some embodiments, the STAs 122, 124 are part of the non-AP MLD 120, such that the non-AP MLD 120 may be a communications device that wirelessly connects to one or more AP MLD. For example, the non-AP MLD 120 may be implemented in a laptop, a desktop personal computer (PC), a mobile phone, or other communications device that supports at least one WLAN communications protocol. In some embodiments, the non-AP STA MLD 120 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the non-AP MLD 120 implements a common MAC functionality and the non-AP STAs 122 and 124 implement a lower layer MAC data functionality. In some embodiments, each STA includes at least one antenna, at least one transceiver operably connected to the at least one antenna, and at least one controller connected to the corresponding transceiver. In some embodiments, at least one transceiver is a PHY device. The at least one controller may be configured to control the at least one transceiver to process packets or frames. In some embodiments, the at least one controller may be implemented within a processor, such as a microcontroller, a host processor, a host, a DSP, or a CPU.

Embodiments disclosed herein are directed to the non-access point (AP) multi-link device (MLD) 120 performing a roaming among the AP MLDs affiliated with the roaming AP MLD 102. In an example, the non-AP MLD 120 may establish a multi-link association with the roaming AP MLD 102 through an AP MLD (e.g., serving AP MLD) of the roaming AP MLD 102. A link is a communication from an STA of the non-AP MLD 120 to the serving AP MLD affiliated with the roaming AP MLD 102. The link may be between a 5 GHz AP and the 5 GHz STA or between the 6 GHz AP and the 6 GHz STA so that the non-AP MLD 120 can execute data frame exchanges (e.g., via a physical layer protocol data unit (PPDU)) with the roaming AP MLD through its serving AP MLD. The non-AP MLD 120 may be mobile and move relative to the AP MLD 106, 108 of the roaming AP MLD 102. Therefore, the non-AP MLD 120 may roam from one AP MLD (e.g., the current serving AP MLD) to another one AP MLD (e.g., future serving AP MLD or target AP MLD) without the need for reassociation with the AP of the roaming AP MLD 104, referred to as smooth roaming. The roaming operation may be a process of changing links from the non-AP MLD 120 to the roaming AP MLD 102 and may be triggered as a result of errors on existing links or high load on an AP MLD of the roaming AP MLD 102 in an example. The non-AP MLD 120 sends a roaming request 126 to the roaming AP MLD 102 through a current serving AP MLD. The roaming request 126 may be newly defined Action frames or Link Reconfiguration Request. The roaming request 126 may indicate an MLD level roaming or link level roaming. The non-AP MLD 120 performs MLD level roaming when all links from the non-AP MLD 120 switch from the current serving AP MLD to the future serving AP MLD at the same time. The non-AP MLD 120 performs link level roaming if during the roaming stage some link(s) of the non-AP MLD is the set-up link of the current serving AP MLD while the other link(s) of the non-AP MLD is the set-up link of the new serving AP MLD (target AP MLD). The roaming request indicates the links to be set up with the target AP MLD of the roaming AP MLD 102 and various capabilities of the STA affiliated with the non-AP MLD 120 coupled to the links which are to be set up. In an example, the roaming AP MLD 102 indicates by an earlier announcement 130 from the roaming AP MLD 102 whether it supports link level roaming or MLD roaming. The links to be set up and the roaming is one of a link level roaming or MLD roaming based on this announcement 130. An AP MLD sends a roaming response 128 to the roaming request 126. The roaming response 128 may be newly defined Action frames or Link Reconfiguration Response associated with 802.11. The roaming response 128 indicates whether the roaming request 126 is accepted and, if accepted, the accepted set up link(s). The roaming response 128 also indicates various capabilities of the APs affiliated with the new serving AP MLD of the roaming AP MLD in the set up links. Based on the accepted roaming response 128, the non-AP MLD 120 is able to perform a smooth roaming within the roaming AP MLD 102 where a transition between AP MLDs occurs without a need for reassociation. In some embodiments, each AP MLD in a distributed AP MLD group has a unique ID such as a MAC SAP address, i.e., a distributed AP MLD MAC SAP address.

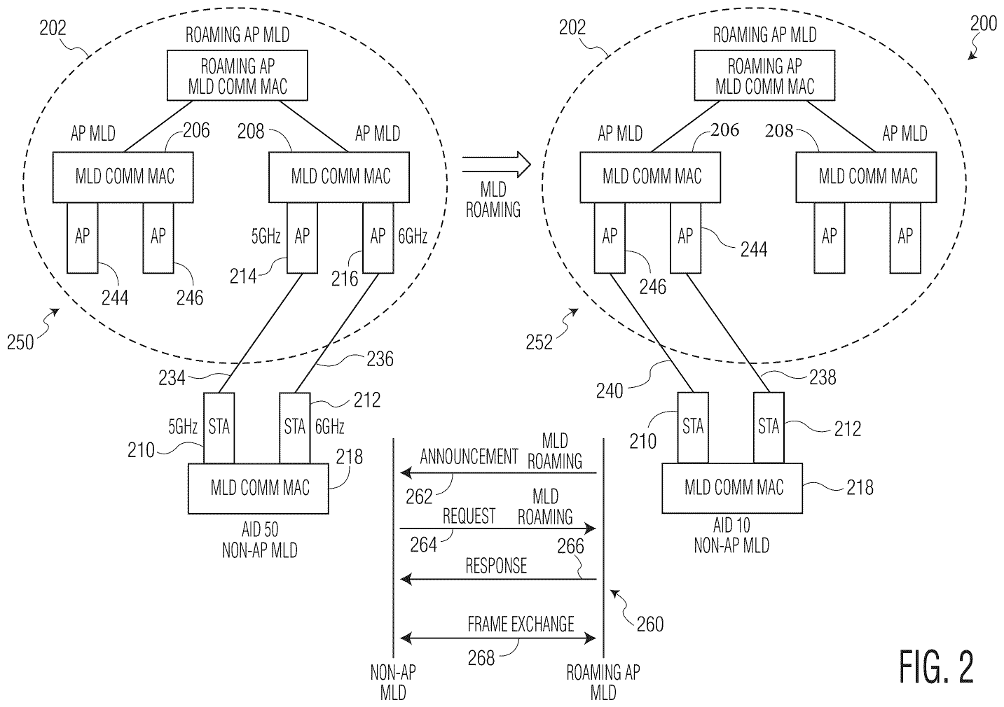

FIG. 2 is an example of MLD level roaming in a multi-link communications system 200 in accordance with an embodiment. The multi-link communications system 200 may have a first arrangement 250 before a non-AP MLD 218 performs a roaming operation and a second arrangement 252 after the non-AP MLD 218 performs the roaming operation.

In the first arrangement 250, the multi-link communications system 200 may have a roaming AP MLD 202 comprising AP MLD 206, 208 and a non-AP MLD 218. Further, the one or more links may be established links between AP MLD 208 of the roaming AP MLD 202 and the non-AP MLD 218 where AP MLD 208 is the current serving AP MLD of the non-AP MLD 218, shown as links 234 and 236 in an example. The link 234 is between the 5 GHz AP 214 affiliated with AP MLD 208 and the 5 GHz STA 210. The link 236 is between the 6 GHz AP 216 affiliated with AP MLD 208 and the 6 GHz STA 212. In this example, the non-AP MLD 218 may execute data frame exchanges with the AP MLD 208 based on an association indicated by an association identifier (AID) such as AID 50. The non-AP MLD 218 may be mobile and can move within the roaming AP MLD 202. Therefore, the non-AP MLD 11 may roam from one AP MLD (i.e., the current serving AP MLD) to another one or more AP MLD (i.e., future serving AP MLD, target AP MLD) without the need for reassociation. The non-AP MLD 218 may roam from the AP MLD 208 to the AP MLD 206, referred to as MLD level roaming. The second arrangement 252 illustrates links 238, 240 established between the target AP MLD of roaming AP MLD 202 and the non-AP MLD 218 after the roaming. Links 234, 236 are terminated and new links 238, 240 are established between AP MLD 206 and the non-AP MLD 218. In the example, the link 240 is between the 5 GHz AP 246 affiliated with the target AP MLD 208 and the 5 GHz STA 210, and the link 238 is between the 6 GHz AP 244 affiliated with the target AP MLD 208 and the 6 GHz STA 212. In this example, the non-AP MLD 218 may execute frame exchanges with the AP MLD 208 based on different association indicated by an association identifier (AID) such as AID 10 but without a reassociation with the roaming AP MLD 202.

Timing diagram 260 illustrates example communication between the non-AP MLD 218 and the roaming AP MLD 202 to perform MLD level roaming. The roaming AP MLD 202 may send an announcement 262 in a management frame or beacon via an AP affiliated with an AP MLD that the roaming AP MLD 202 supports MLD level roaming. Then, the non-AP MLD 218 may send a roaming request 264 for MLD level roaming to the roaming AP MLD 202 to request the current serving AP MLD to switch in accordance with the MLD level roaming and the roaming AP MLD 202 may send a roaming response 266 to the non-AP MLD 218. The roaming response indicates whether the roaming request is accepted and, if accepted, indicates the accepted setup link(s) with the new serving or target AP MLD. The roaming AP MLD 202 also establishes a frame exchange context in the new serving AP MLD 206 and the roaming response is sent to notify a readiness for frame exchange between the non-AP MLD 218 and the new serving AP MLD 206. The frame exchange context may include one or more of a pairwise master key (PTK), pairwise transient key (PTK) an unassigned sequence number (SN) for downlink traffic, a sequence number of unicast frames, block acknowledgement related parameters, and a packet number in an example. In an example, the SN may be provided to upper layers for uplink traffic. After a frame exchange context is established in the new serving MLD 206, the non-AP MLD 218 and the AP MLD 206 is able to perform a frame exchange 268 such as a class 3 frame exchange. Class 3 frames may be data frames (in contrast to control frames) exchanged when an STA has been successfully authenticated and associated with an access point.

In an example, the roaming request 262 and roaming response 264 may be transmitted through setup links 234, 236 of the current serving AP MLD 208. In an example, the roaming request 264 may carry an AP MLD identifier of the new serving AP MLD 206, e.g., AP MLD roaming ID (the identifier of the AP MLD 206 in the roaming AP MLD 202) such as the MAC SAP address of the new serving AP MLD 206. Further, the roaming AP MLD 202 determines the current serving AP MLD 208 through the MAC SAP address of the non-AP MLD 218. In some examples, the roaming request 262 and the response 264 may be transmitted via a link to the new serving AP MLD 206. In an example, the roaming request 262 and roaming response 266 may be transmitted in a same link. Further, the STAs 210, 212 of the non-AP MLD 218 may be in power save mode before roaming and may be in a doze state after the roaming to AP 246, 244, respectively.

In some examples, a target roaming time may be negotiated through the roaming request and roaming response frame. The target roaming time may indicate when the roaming from the current serving AP MLD 208 to the new serving AP MLD 206 is to be completed and the non-AP MLD 218 is able to exchange frames with the new serving AP MLD 206. In some example, instead of indicating the target roaming time, another management frame exchange after the roaming request/response is used to notify when the roaming from the current serving AP MLD 208 to the new serving AP MLD 206 is completed. After transmitting the roaming response frame 266, the current serving AP MLD 208 cannot transmit the frames to the non-AP MLD 218 because the non-AP MLD 218 does not consider the current serving AP MLD 208 as the serving AP MLD anymore. Further, after receiving the roaming response 266, the non-AP MLD 218 does not transmit the frames to current the serving AP MLD 208 because the non-AP MLD 218 does not consider the current serving AP MLD 208 as the serving AP MLD. During a time that the roaming AP MLD 202 establishes the frame exchange context in the new serving AP MLD 206, the non-AP MLD 218 may not perform any frame exchanges with the roaming AP MLD 202.

The request carries the various capabilities and operating parameters of the STAs 210, 212 affiliated with the non-AP MLD 218, the Multi Link clement to indicate the full information of the STA 210, 212 that the non-AP MLD 218 wants to do the frame exchanges with the new serving AP MLD 206. A roaming response indicates whether the request is accepted and, if accepted, indicates the accepted set up link(s). The roaming response also carries the various capabilities and operating parameters of the AP 244, 246 affiliated with the new serving AP MLD 206 in the accepted links, a Multi-Link clement to indicate the full information of the APs 244, 246 that the non-AP MLD 218 wants to do the frame exchanges with the new serving AP MLD 206.

In some examples, the roaming AP MLD 202 may suggest the roaming of non-AP MLD 218 through a roaming query frame. In some examples, the roaming AP MLD 202 may suggest the roaming of non-AP MLD 218 through BSS transition management procedure. In some examples, the roaming AP MLD 202 may suggest the roaming of non-AP MLD 218 through a newly defined procedure. The roaming may be suggested because of errors on the existing link or excess load on a AP MLD. Further, the roaming query may be newly defined Action frames or Action frames or Link Reconfiguration Query. In some examples, the non-AP MLD initiates its roaming procedure after receiving the suggestion from the roaming AP MLD.

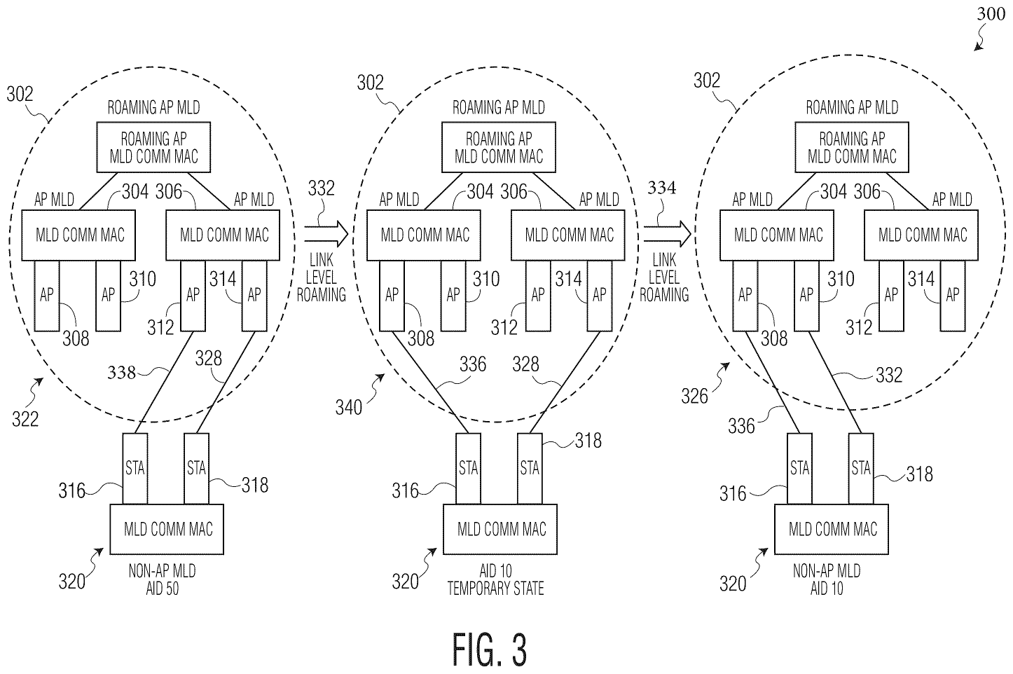

FIG. 3 is an example of a link level roaming in a multi-link communications system 300 in accordance with an embodiment. The multi-link communications system 300 may have a first arrangement 322 before the non-AP MLD 320 performs a roaming operation 332 and a second arrangement 340 after the non-AP MLD 320 performs the roaming operation 332. A second arrangement 340 may be a temporary state where the non-AP MLD 320 is able to perform frame exchanges with both the current serving AP MLD and the target AP MLD. The non-AP 320 may enter into temporary state when all links from the non-AP MLD 320 to the roaming AP MLD 302 change from being coupled to only one serving AP MLD 306 to more than one serving AP MLD 304, 306. The non-AP MLD 320 may perform another roaming operation 334 in the temporary state to reach a third arrangement 326 where all links of the non-AP MLD 320 is coupled to the target serving AP MLD.

In the first arrangement 322, the multi-link communications system 300 may have a roaming AP MLD 302 comprising AP MLD 304, 306 and a non-AP MLD 320. The first arrangement 322 may be a state of the multi-link communications system 300 where the non-AP MLD 320 is able to perform class 3 frame exchange with the roaming AP MLD 302 through the serving AP MLD 306. The non-AP MLD 320 may have link 338 from the non-AP MLD 320 to a current serving AP MLD 306 and a link 328 from the non-AP MLD 320 to the same current serving AP MLD 306. The non-AP MLD 320 may perform a roaming operation 332 such that multi-link communications system 300 is in the second arrangement 340.

The roaming operation 332 may involve the non-AP MLD 320 changing some of its links to a new serving AP MLD while keeping some links at a current serving AP MLD. In the second arrangement 340, the non-AP MLD 320 may terminate link 338 from the non-AP MLD 320 to the current serving AP MLD 306 (the operation of deleting link) and establish link 336 to a new serving AP MLD 304 (the operation of adding link) while still having link 328 from the non-AP MLD 320 to the current serving AP MLD 306.

To facilitate the roaming 332, the roaming AP MLD 302 may send an announcement that the roaming AP MLD 302 supports link level roaming in a management frame or beacon via an AP affiliated with an AP MLD, the AP MLD further affiliated with the roaming AP MLD 302. Then, the non-AP MLD 320 may send a roaming request to the roaming AP MLD 302 to set up links in accordance with the link level roaming and the roaming AP MLD 302 may send a roaming response to the non-AP MLD 320. The roaming response indicates whether the roaming request is accepted and, if accepted, indicates the accepted setup link(s). The roaming AP MLD 302 also establishes a frame exchange context for the new serving AP MLD 304. After a frame exchange context is established in the new serving MLD 304, the non-AP MLD 320 and the AP MLD 304, 306 is able to perform a class 3 frame exchange.

In an example, the roaming request and roaming response may be transmitted through setup links 338, 328 of the current serving AP MLD 306. In an example, the roaming request may carry an AP MLD identifier of the new serving AP MLD 304, e.g., AP MLD roaming ID (the identifier of the AP MLD 304 in the roaming AP MLD 302) of the new serving AP MLD 304 such as the MAC SAP address of the new serving AP MLD 304. In another example, the roaming request and roaming response may be transmitted via a link of the new serving AP MLD 304. In an example, the roaming request and roaming response may be transmitted in a same link. The request may carry the AP MLD identifier of the current serving AP MLD 306, e.g., AP MLD roaming ID (the identifier of the AP MLD 306 in the roaming AP MLD 302) of the current serving AP MLD 306 such as the MAC SAP address of the current serving AP MLD 306. Alternatively, the roaming AP MLD 302 determines the current serving AP MLD 306 through the MAC SAP address of the non-AP MLD 320. Further, the STA 316 of the non-AP MLD 320 may be in power save mode and in a doze state at the AP 308 of the new serving AP MLD 304 during the roaming.

In some examples, the roaming AP MLD 302 may suggest the roaming of a non-AP MLD 320 through a roaming query frame such as a Link Reconfiguration Query, BSS transition management procedure, or the new defined procedure. Further, the roaming query and the roaming request, roaming response can be newly defined Action frames or Link Reconfiguration Query, Link Reconfiguration Request, or Link Reconfiguration Response. The roaming request carries the various capabilities and operating parameters of the STAs 316, 318 affiliated with the non-AP MLD 320, the Multi Link element to indicate the full information of the STA 316, 318 that the non-AP MLD 320 wants to do the frame exchanges with the new serving AP MLD 304. The roaming response indicates whether the roaming request is accepted and, if accepted, indicates the accepted set up link(s). The roaming response also carries the various capabilities and operating parameters of the AP 308 affiliated with the new serving AP MLD 304 in the accepted links, a Multi-Link clement to indicate the full information of the AP 308 that the non-AP MLD 320 wants to do the frame exchanges with the new serving AP MLD 304.

Further, the roaming AP MLD 302 may establish a frame exchange context in the new serving AP MLD 304 for the non-AP MLD 320. The frame exchange context may include one or more of a pairwise master key (PTK), pairwise transient key (PTK) an unassigned sequence number (SN) for downlink traffic, a sequence number of unicast frames, block acknowledgement related parameters, and a packet number in an example. In an example, the SN may be provided to upper layers for uplink traffic. During the time that the frame exchange context is being established with the new serving AP MLD 304, the non-AP MLD 320 cannot do the frame exchanges with the roaming AP MLD 302 through the new serving AP MLD 304. The frame exchange context may include a sequence number of unicast frames, block acknowledgement related parameters, a packet number, and pairwise transient keys in an example and the roaming response is sent to notify a readiness for frame exchange between the non-AP MLD 320 and the new serving AP MLD 304. After a frame exchange context is established in the new serving AP MLD 304, the non-AP MLD 320 and the AP MLD 304 is able to perform a frame exchange such as a class 3 frame exchange through the new serving AP MLD 304 in the second arrangement 340.

After transmitting the roaming response, the current serving AP MLD 306 can transmit class 3 frames to the non-AP MLD 30 through the setup link(s) 328. Also, after transmitting the roaming response, an AP 308 of the new serving AP MLD 304 can transmit the frames to the STA 316 of the non-AP MLD 320 in the setup link 336 if the STA 316 is in active mode or awake state. The non-AP MLD 320 uses the new setup link(s) 336 with the new serving AP MLD 320 and the remaining setup link(s) 328 with current serving AP MLD 306 for the frame exchanges to facilitate further smooth roaming. Further, the non-AP MLD 320 uses the link(s) 328 with the current serving AP MLD 306 to transmit uplink frames to the AP MLD 306 until the roaming AP MLD 302 finishes the frame exchange context in the new setup link(s) 336 with the new serving AP MLD 304, in which case the non-AP MLD 320 only uses the link(s) 336 with the new serving AP MLD 304 to transmit the uplink frames. At the same time, the non-AP MLD 320 may acquire downlink frames from both current serving AP MLD 306 and the new serving AP MLD 304.

The second arrangement 340 of the multi-link communications system 300 may be a temporary state where the non-AP MLD 320 can exchange class 3 frames with two serving AP MLDs. The non-AP MLD 320 may perform a roaming operation 334 to change links (adding the link to the new serving AP MLD 304 and deleting/terminating the link with the current serving AP MLD 306) so that a single AP MLD 304 serves the non-AP MLD 320. The non-AP MLD 320 may delete/terminate a link(s) 328 from the non-AP MLD 320 to a current serving AP MLD 306 and add a link 332 from the non-AP MLD 320 to the new serving AP MLD 304 so that no link(s) from the non-AP MLD 320 to the current serving AP MLD 306 remain and a single AP MLD 304 serves the non-AP MLD 320. A non-AP MLD 302 that performs the roaming 334 may send a roaming request to the roaming AP MLD 302 and the roaming AP MLD 302 sends the roaming response to the non-AP MLD 320. The roaming response may indicate whether the roaming request is accepted and if accepted, the accepted setup links. If the roaming AP MLD 302 accepts the roaming request and the roaming AP MLD 302 establishes the frame exchange context in the new serving AP MLD 304 for the non-AP MLD 320, the roaming AP MLD 302 sends the roaming response to notify the readiness of frame Tx/Rx to/from the non-AP MLD 320 in the new serving AP MLD 304. After transmitting the roaming response, the current serving AP MLD 306 may not be used to transmit the frames to the non-AP MLD 320. After transmitting the roaming response, an AP 310 of the new serving AP MLD 304 may transmit the frames to the STA 318 of the non-AP MLD 320 when the STA 318 is in active mode or awake state. Further, the non-AP MLD 320 may use the new set up link(s) 332 with the new serving AP MLD 304 to transmit the frames to the new serving AP MLD 304. This third arrangement 326 may be a normal state in which the non-AP MLD 320 and roaming AP MLD 302 may exchange class 3 frames.

In some examples, the roaming request or roaming response may indicate a target roaming time which is negotiated. The target roaming time may indicate when the non-AP 320 is able to exchange class 3 frames with the new serving AP MLD 304 in a normal state in contrast to the temporary state. In this regard, the time may include time to complete the roaming 332 and roaming 334.

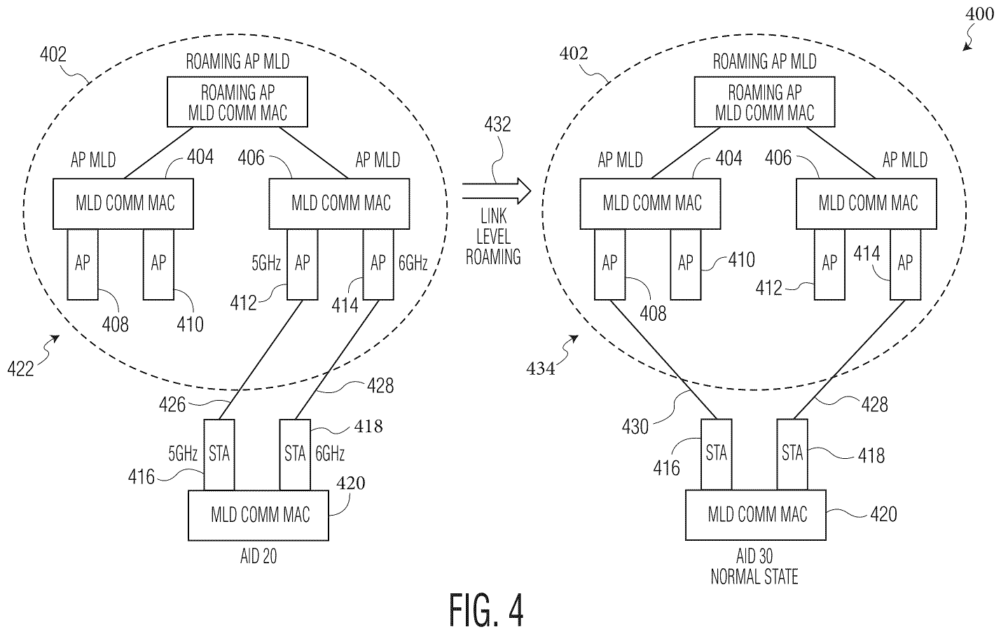

FIG. 4 is another example of a link level roaming in a multi-link communications system 400 in accordance with an embodiment. In an example, a non-AP MLD 420 may roam to a normal state with multiple serving AP MLDs rather than a temporary state, and can be used for smooth roaming and class 3 frame exchanges. The multi-link communications system 400 may have a first arrangement 422 before the non-AP MLD 420 performs a roaming operation 432 and a second arrangement 434 after the non-AP MLD 420 performs the roaming operation 432. In the first arrangement 422, the multi-link communications system 400 may have a roaming AP MLD 402 comprising AP MLD 404, 406 and a non-AP MLD 420. The second arrangement 434 may be the normal state where the non-AP MLD 420 is able to perform smooth roaming and class 3 frame exchange with multiple serving AP MLD rather than a temporary state. The non-AP 420 may enter into the normal state when links 426, 428 from the non-AP MLD 420 to the roaming AP MLD 402 change from being coupled from only one serving AP MLD 406 to more than one serving AP MLD 404, 406.

The first arrangement 422 may be a state of the multi-link communications system 400 where the non-AP MLD 420 is able to perform class 3 frame exchange with the roaming AP MLD 402. The non-AP MLD 420 may have link 426 from the non-AP MLD 420 to a current serving AP MLD 406 and a link 428 from the non-AP MLD 420 to the same current serving AP MLD 406. The non-AP MLD 420 may perform a link level roaming operation 432 such that multi-link communications system 400 is in the second arrangement 434. The roaming operation 432 may involve the non-AP MLD 420 changing some of its links to a new serving AP MLD while keeping some links at a current serving AP MLD. In roaming to the second arrangement 434, the non-AP MLD 420 may terminate link 426 from the non-AP MLD 420 to the current serving AP MLD 406 and establish link 430 to a new serving AP MLD 404 while still having link 428 from the non-AP MLD 420 to the current serving AP MLD 406.

To facilitate the roaming 432, the roaming AP MLD 402 may send an announcement that the roaming AP MLD 402 supports link level roaming and multiple serving AP MLDs in a management frame or beacon via an AP affiliated with an AP MLD of the roaming AP MLD 402. Then, the non-AP MLD 420 may send a roaming request to the roaming AP MLD 402 to set up links in accordance with the link level roaming and the roaming AP MLD 402 may send a roaming response to the non-AP MLD 420. The roaming response indicates whether the roaming request is accepted and, if accepted, indicates the accepted setup link(s). The roaming AP MLD 402 also establishes a frame exchange context in the new serving AP MLD 404 for the frame exchange with the non-AP MLD 420. After a frame exchange context is established in the new serving MLD 404, the non-AP MLD 420 and the AP MLD 404, 406 is able to perform a frame exchange which includes class 3 frame exchange because the second arrangement 434 is the state after the roaming response frame and readiness of frame exchange context.

In an example, the current serving AP MLD 406 can transmit and receive the frames to the non-AP MLD 420 through the setup link(s) of the current serving AP MLD 406 that remains after transmitting the roaming response. After transmitting the roaming response, an AP 408 of the new serving AP MLD 404 in a setup link can transmit and receive the frames to the STA of the non-AP MLD in the setup link if the STA is in active mode or awake state. The non-AP MLD 420 uses the new setup link(s) with the new serving AP MLD and the remaining setup link(s) with current serving AP MLD to facilitate the roaming.

The announcement that the roaming AP MLD 202, 302, 402 transmits to the non-AP MLD 220, 320, 420 in the multi-link communication systems 200, 300, 400 may indicate support for various link-related operations.

In one example, the roaming AP MLD may announce whether it supports one traffic identifier (TID) being mapped to the links between a non-AP MLD and more than one AP MLD serving the non-AP MLD for both uplink and downlink communication. Alternatively, the roaming AP MLD may announces whether it supports one TID being mapped between a non-AP MLD and more than one AP MLD serving the non-AP MLD for uplink communication. In an example, the non-AP MLD and the roaming MLD may announce that each TID is mapped to a link(s) of only one serving AP MLD or each TID may be mapped to the link(s) of only one serving AP MLD for uplink communication.

If frames with one TID are sent over multiple links e.g. during the roaming stage under link level roaming, the roaming AP MLD may need a reorder buffer, e.g. in the new serving AP MLD to reorder the frames of the same TID in order based on a sequence numbering for processing while if frames with one TID are sent over one link, the roaming AP MLD may not need a reorder buffer. The reordering may occur in upper level MAC processing of the new serving AP MLD. In an example, a non-AP MLD may not have multiple serving AP MLDs affiliated with a roaming AP MLD if the roaming AP MLD does not support one TID being mapped to the links of more than one serving AP MLD of a non-AP MLD, and the non-AP MLD doesn't negotiate the different TIDs being mapped to different links. In an example, each uplink TID can only be mapped to the link(s) of one serving AP MLD if the roaming AP MLD does not support one TID being mapped to the links of more than one serving AP MLD of a non-AP MLD.

In another example, the roaming AP MLD may announce whether it supports a non-simultaneous transmit and receive (NSTR) link pair operation when the NSTR link pair is respective links between the non-AP MLD and two serving AP MLDs. The two links that belong to respective serving AP MLDs cannot be an NSTR link pair because, for such a link pair, it may be difficult to perform the PPDU alignment in the link pair with the APs in different AP MLDs. In an example, a non-AP MLD may not have multiple serving AP MLDs affiliated with a roaming AP MLD when the NSTR link pair belongs to two serving AP MLDs and the non-AP MLD has an NSTR link pair for the links that belong to the two serving AP MLDs. In an example, for a NSTR link pair that belong to two serving AP MLDs, only one link can be used at any time to a serving AP MLD.

In yet another example, the roaming AP MLD may announce whether it supports the enhanced multi-link single radio (eMLSR)/enhanced multi-link multiple radio (eMLSR) operation when the EMLSR/EMLMR links are respective links between the non-AP MLD and two serving AP MLDs. In eMLSR, the roaming AP MLD uses two radios in different bands to communicate with the non-AP MLD. For example, one radio may be a lower cost radio with lesser capabilities and the other radio may be a fully functional radio supporting latest protocols. An AP MLD may listen on both links, but can only transmit through one link at any time with the fully functional radio. In eMLMR, each link has its own radio different bands and the AP MLD is able to transmit or receive through both links.

In an example, the roaming AP MLD may not support EMLSR/EMLMR operation for the links that belong to multiple serving AP MLDs. In an example, a non-AP MLD may not negotiate the EMLSR/EMLMR mode with the roaming AP MLD for the links that belong to multiple serving AP MLDs affiliated with a roaming AP MLD if the roaming AP MLD announces that it does not support the EMLSR/EMLMR operation when the EMLSR/EMLMR links belong to multiple serving AP MLDs. Another variant is that a serving AP MLD can reject the EMLSR/EMLMR request from an non-AP MLD if the EMLSR/EMLMR request includes the links that belong to multiple serving AP MLDs or the serving AP MLD announces that does not support the EMLSR/EMLMR operation when the EMLSR/EMLMR links belong to multiple serving AP MLDs. In another example, for the EMLSR/EMLMR operation with the EMLSR/EMLMR links that belong to multiple serving AP MLDs, only one link can be in active mode or awake state.

In an example, the frame exchange context that is established by the roaming AP MLD facilitates performing frame exchanges between two peer AP MLDs and the non-AP MLD. The peer AP MLD may be a serving AP MLD of the roaming AP MLD. The context may define one or more capabilities of the AP affiliated with the serving AP MLDs for each link, the link pair capabilities of each established link pair from the non-AP MLD to the peer AP MLD, the BSS operating parameters of each established link, and the capabilities of the STA affiliated with each established link. The frame exchange context may also include one or more of a sequence number of unicast frames, block acknowledgement related parameters, a packet number, replay counter, and pairwise transient key in an example. As part of establishing the frame exchange context, the roaming AP MLD may share the capabilities and parameters of APs affiliated with serving AP MLDs between the serving AP MLDs to facilitate the frame exchange.

In an example, information (e.g., capabilities, parameters) of the APs affiliated with the new serving AP MLD and the information of the non-AP MLD are acquired through the roaming request and roaming response frame. In an example, the roaming request carries the information of the non-AP MLD and the roaming response carry the information of the new serving AP MLD. The STA of an MLD may have a profile that defines its capabilities and parameters. In one example, APs associated with the requested/established links of the new serving AP MLD do not inherit per STA profiles (STA capabilities) from the other APs of the new serving AP MLD associated with requested/established links. The per STA profiles of each link is separately provided by the roaming request. In another example, APs associated with the requested/established links of the new serving AP MLD whose per STA profile is not the first per STA profile inherit the first per STA profiles (STA capabilities) of the AP associated with requested/established links. In yet another example, the per STA profiles of each AP associated with the requested/established links (reported links) of the new serving AP MLD inherit the information of the AP (the information of the reporting link) which transmits the roaming response frame.

In an example, information of the new serving AP MLD and the information of the non-AP MLD are acquired through the management frames exchanged after the roaming request and before the roaming response. In an example, information of the new serving AP MLD and the information of the non-AP MLD are acquired through the management frames exchanged before the roaming request. In an example, information of the new serving AP MLD and the information of the non-AP MLD are acquired through the management frames exchanged after the roaming response frame. The management frame may be a multi-link (ML) probe request/response transmitted through the established link(s) of the current serving AP MLD or through the link of the new serving AP MLD which allows the non-AP to request capabilities, information of APs of an AP MLD.

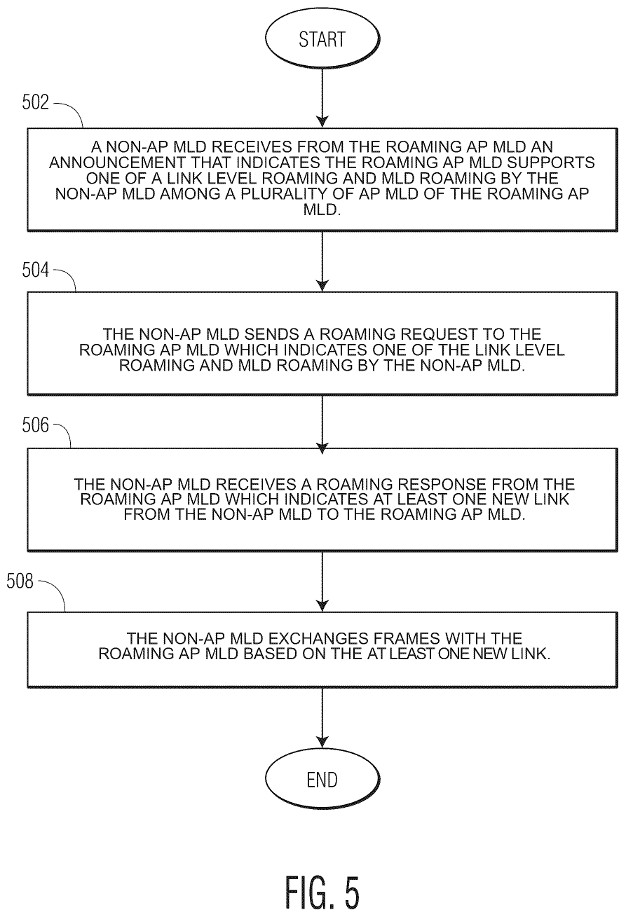

FIG. 5 is a flow chart of functions associated with roaming in the communication system in accordance with an embodiment. Functions may be performed in the multi-link wireless communication network 200, 300, 400 in an example.

At 502, a non-AP MLD receives from the roaming AP MLD an announcement that indicates the roaming AP MLD supports one of a link level roaming and MLD roaming by the non-AP MLD among a plurality of AP MLD of the roaming AP MLD. Further, the announcement may indicate whether link level roaming restrictions are present such as whether the TID is mapped to multiple links, whether serving links can be NSTR pairs, or whether the roaming AP MLD supports EMLSR/EMLMR. The announcement may be received by an STA affiliated with the non-AP MLD in a beacon or management frame in an example. The link level roaming comprises changing less than all links to the roaming AP MLD such that a current AP MLD and new AP MLD serves the non-AP MLD and the MLD roaming comprises changing all links to the roaming AP MLD to a new serving AP MLD. The non-AP MLD may roam within the roaming AP MLD from one AP MLD to another AP MLD. At 504, the non-AP MLD sends a roaming request to the roaming AP MLD which indicates one of the link level roaming and MLD roaming by the non-AP MLD. The type of roaming is based on the announcement from the roaming AP MLD and an indication of which links to terminate or establish with the roaming AP MLD. The roaming request may be sent via established links or links to a new serving AP MLD and be newly defined Action frames or Link Reconfiguration Request. At 506, the non-AP MLD receives a roaming response from the roaming AP MLD which indicates at least one new link from the non-AP MLD to the roaming AP MLD. In an example, the roaming response may be a newly defined Action frames or BSS Transition Management Link Reconfiguration Response. Further, the roaming response may indicate that the roaming AP MLD shared a frame exchange context with the new serving AP MLD. Further, the roaming AP MLD may cause STA profiles to be inherited from one AP MLD to another AP MLD. At 508, the non-AP MLD exchanges frames with the roaming AP MLD based on the at least one new link. The communication may be class 3 frames if a state of the multi-link wireless communication system is a normal state or frames other than class 3 frames if a state of the multi-link wireless communication system is a temporary state. Further, in some examples, only one serving AP MLD may be used for a TID for uplink frame exchange or both uplink and downlink frame exchange with the non-AP MLD. In the case that the state is a temporary state, the non-AP MLD may perform a further roaming to reach a normal state. Further, the roaming request and roaming response may be transmitted in established links or newly set up links.

In an embodiment, a method for a non-access point (non-AP) multi-link device (MLD) to roam among a plurality of AP MLDs of a roaming AP MLD is disclosed. The method comprises: receiving from the roaming AP MLD an announcement, the announcement indicating that the roaming AP supports one of a link level roaming and MLD roaming within the roaming AP MLD, wherein the link level roaming comprises terminating less than all links from the non-AP MLD to respective AP MLD of the roaming AP MLD and establishing at least one new link from the non-AP MLD to an AP MLD of the roaming AP MLD different from an AP MLD associated with the one or more terminated links and the MLD roaming comprises terminating all links from the non-AP MLD to a first AP MLD of the roaming AP MLD and establishing at least one new link from the non-AP MLD to a second AP MLD; sending a roaming request to the roaming AP MLD, wherein the roaming request indicates one of the link level roaming and MLD roaming based on the announcement; receiving a roaming response from the roaming AP MLD, the response indicating the at least one new link established from the non-AP MLD to the roaming AP MLD; and exchanging one or more frames between the non-AP MLD and the roaming AP MLD based on the at least one new link established from the non-AP MLD to the roaming AP MLD. In an example, the roaming request indicates a time when the non-AP MLD is able to exchange frames with the roaming AP MLD via the at least one new link. In an example, the method further comprises not using the at least one new link to the roaming AP MLD to transmit uplink frames to the roaming AP MLD until the roaming response is received and receiving downlink frames from the roaming AP MLD using the at least one new link until the roaming response is received. In an example, the non-AP MLD uses a link with a current serving AP MLD until the non-AP MLD completes a frame exchange context in the new link with a new serving AP MLD, the non-AP MLD using the new link with the new serving AP MLD to transmit uplink frames when the frame exchange context is completed and receiving downlink frames from the current serving AP MLD and the new serving AP MLD. In an example, the frame exchange context includes one or more of a pairwise master key (PTK), pairwise transient key (PTK) context of the non-AP MLD, and an unassigned sequence number (SN) for downlink traffic. In an example, the announcement indicates whether the roaming AP MLD supports one traffic identifier (TID) being mapped to links from the non-AP STA to two AP affiliated with different AP MLDs of the roaming AP MLD. In an example, exchanging the one or more frames comprises exchanging the one or more frames to only a single AP MLD of the roaming AP MLD when the roaming AP MLD does not support one TID being mapped to links of different AP MLD. In an example, the announcement indicates whether the roaming AP MLD supports links from the non-AP STA to the roaming AP MLD being an NSTR link pair to two AP affiliated with two different AP MLDs of the roaming AP MLD. In an example, exchanging the one or more frames comprises exchanging the one or more frames to only a single AP MLD of the roaming AP MLD when an NSTR link pair is to different AP MLDs of the roaming AP MLD. In an example, the announcement indicates whether the roaming AP MLD supports links from the non-AP STA to the roaming AP MLD being enhanced multi-link single radio (eMLSR) or enhanced multi-link multiple radio (eMLSR) links from the non-AP STA to two AP of two different AP MLDs affiliated with the roaming AP MLD. In an example, exchanging the one or more frames comprises exchanging the one or more frames to only a single AP MLD of the roaming AP MLD when the roaming AP MLD does not support links to the roaming AP MLD being EMLSR or EMLMR links to two different AP MLD affiliated with the roaming AP MLD. In an example, receiving the roaming response comprise receiving the response over the at least one new link which is established. In an example, the roaming request carries a medium access service access point (MAC SAP) address of an AP MLD affiliated with the roaming AP MLD to which one of the at least one new links to be established.

In another embodiment, a non-access point (non-AP) multi-link device (MLD) arranged to roam among a plurality of AP MLDs of a roaming AP MLD is disclosed. The non-AP MLD comprises circuitry to receive from the roaming AP MLD an announcement, the announcement indicating that the roaming AP supports one of a link level roaming and MLD roaming within the roaming AP MLD, wherein the link level roaming comprises terminating less than all links from the non-AP MLD to respective AP MLD of the roaming AP MLD and establishing a new link from the non-AP MLD to an AP MLD of the roaming AP MLD different from an AP MLD associated with the one or more terminated links and the MLD roaming comprises terminating all links from the non-AP MLD to a first AP MLD of the roaming AP MLD and establishing at least one new link from the non-AP MLD to a second AP MLD; send a roaming request to the roaming AP MLD, wherein the roaming request indicates one of the link level roaming and MLD roaming based on the announcement; receive a roaming response from the roaming AP MLD, the response indicating the at least one new link established from the non-AP MLD to the roaming AP MLD; and exchange one or more frames between the non-AP MLD and the roaming AP MLD based on the at least one new link established from the non-AP MLD to the roaming AP MLD. In an example, the roaming response indicates a time when the non-AP MLD is able to exchange frames with the roaming AP MLD via the at least one new links. In an example, the non-AP MLD is arranged with circuity to not use the at least one new link to the roaming AP MLD to transmit uplink frames to the roaming AP MLD until the roaming response is received and receive downlink frames from the roaming AP MLD using the at least one new link until the roaming response is received. In an example, the announcement indicates whether the roaming AP MLD supports one TID being mapped to links from the non-AP STA to two AP affiliated with different AP MLDs of the roaming AP MLD. In an example, the circuity arranged to exchange one or more frames comprises circuity for exchanging class 3 frames defined by IEEE 802.11 when links from the non-AP MLD to the roaming AP MLD change from links to two AP MLD of the roaming AP MLD to links to only one AP MLD of the roaming AP MLD. In an example, the non-AP MLD is arranged to use a link with a current serving AP MLD until the non-AP MLD completes a frame exchange context in the new link with a new serving AP MLD, the non-AP MLD using the new link with the new serving AP MLD to transmit uplink frames when the frame exchange context is completed and receiving downlink frames from the current serving AP MLD and the new serving AP MLD. In an example, the frame exchange context includes one or more of a pairwise master key (PTK), pairwise transient key (PTK) context of the non-AP MLD, and an unassigned sequence number (SN) for downlink traffic.

In yet another embodiment, an access point (AP) multi-link device (MLD) of a roaming AP MLD which comprises a plurality of AP MLD is disclosed. The AP MLD comprises circuitry to transmit an announcement to a non-AP MLD roaming among the plurality of AP MLD, the announcement indicating that the roaming AP supports one of a link level roaming and MLD roaming within the roaming AP MLD, wherein the link level roaming comprises terminating less than all links from the non-AP MLD to respective AP MLD of the roaming AP MLD and establishing a new link from the non-AP MLD to an AP MLD of the roaming AP MLD different from an AP MLD associated with the one or more terminated links and the MLD roaming comprises terminating all links from the non-AP MLD to a first AP MLD of the roaming AP MLD and establishing at least one new link from the non-AP MLD to a second AP MLD; receive a roaming request to the roaming AP MLD, wherein the roaming request indicates one of the link level roaming and MLD roaming based on the announcement; send a roaming response to the non-AP MLD, the response indicating the at least one new link established from the non-AP MLD to the roaming AP MLD; and exchange one or more frames between the non-AP MLD and the roaming AP MLD based on the at least one new link established from the non-AP MLD to the roaming AP MLD. In an example, one AP of the AP MLD of the roaming AP MLD which serves the non-AP MLD inherits a per STA profile of the non-AP MLD from another AP MLD of the roaming AP MLD. In an example, the AP MLD further comprises circuitry to terminate a link from the non-AP MLD to the AP MLD or establish a link from the non-AP MLD to the AP MLD in response to the request. In an example, the circuitry to send the roaming response comprises circuitry to send the roaming response based on a time indicated in the roaming request when the non-AP MLD is able to exchange frames with the roaming AP MLD via the at least one new link.

The foregoing disclosure provides illustration and description but is not intended to be exhaustive or to limit the aspects to the precise form disclosed. Modifications and variations may be made in light of the above disclosure or may be acquired from practice of the aspects.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method for a non-access point (non-AP) multi-link device (MLD) to roam among a plurality of AP MLDs of a roaming AP MLD, the method comprising:
receiving from the roaming AP MLD an announcement, the announcement indicating that the roaming AP supports one of a link level roaming and MLD roaming within the roaming AP MLD, wherein the link level roaming comprises terminating less than all links from the non-AP MLD to respective AP MLD of the roaming AP MLD and establishing at least one new link from the non-AP MLD to an AP MLD of the roaming AP MLD different from an AP MLD associated with the one or more terminated links and the MLD roaming comprises terminating all links from the non-AP MLD to a first AP MLD of the roaming AP MLD and establishing at least one new link from the non-AP MLD to a second AP MLD;
sending a roaming request to the roaming AP MLD, wherein the roaming request indicates one of the link level roaming and MLD roaming based on the announcement;
receiving a roaming response from the roaming AP MLD, the response indicating the at least one new link established from the non-AP MLD to the roaming AP MLD; and
exchanging one or more frames between the non-AP MLD and the roaming AP MLD based on the at least one new link established from the non-AP MLD to the roaming AP MLD.

2. The method of claim 1, wherein the roaming request indicates a time when the non-AP MLD is able to exchange frames with the roaming AP MLD via the at least one new link.

3. The method of claim 1, further comprising not using the at least one new link to the roaming AP MLD to transmit uplink frames to the roaming AP MLD until the roaming response is received and receiving downlink frames from the roaming AP MLD using the at least one new link until the roaming response is received.

4. The method of claim 3, wherein the non-AP MLD uses a link with a current serving AP MLD until the non-AP MLD completes a frame exchange context in the new link with a new serving AP MLD, the non-AP MLD using the new link with the new serving AP MLD to transmit uplink frames when the frame exchange context is completed and receiving downlink frames from the current serving AP MLD and the new serving AP MLD.

5. The method of claim 4, wherein the frame exchange context includes one or more of a pairwise master key (PTK), pairwise transient key (PTK) context of the non-AP MLD, and an unassigned sequence number (SN) for downlink traffic.

6. The method of claim 1, wherein the announcement indicates whether the roaming AP MLD supports one traffic identifier (TID) being mapped to links from the non-AP STA to two AP affiliated with different AP MLDs of the roaming AP MLD.

7. The method of claim 6, wherein exchanging the one or more frames comprises exchanging the one or more frames to only a single AP MLD of the roaming AP MLD when the roaming AP MLD does not support one TID being mapped to links of different AP MLD.

8. The method of claim 1, wherein the announcement indicates whether the roaming AP MLD supports links from the non-AP STA to the roaming AP MLD being an NSTR link pair to two AP affiliated with two different AP MLDs of the roaming AP MLD.

9. The method of claim 8, wherein exchanging the one or more frames comprises exchanging the one or more frames to only a single AP MLD of the roaming AP MLD when an NSTR link pair is to different AP MLDs of the roaming AP MLD.

10. The method of claim 1, wherein the announcement indicates whether the roaming AP MLD supports links from the non-AP STA to the roaming AP MLD being enhanced multi-link single radio (eMLSR) or enhanced multi-link multiple radio (eMLSR) links from the non-AP STA to two AP of two different AP MLDs affiliated with the roaming AP MLD.

11. The method of claim 10, wherein exchanging the one or more frames comprises exchanging the one or more frames to only a single AP MLD of the roaming AP MLD when the roaming AP MLD does not support links to the roaming AP MLD being EMLSR or EMLMR links to two different AP MLD affiliated with the roaming AP MLD.

12. The method of claim 1, wherein receiving the roaming response comprise receiving the response over the at least one new link which is established.

13. The method of claim 1, wherein the roaming request carries a medium access service access point (MAC SAP) address of an AP MLD affiliated with the roaming AP MLD to which one of the at least one new links to be established.

14. A non-access point (non-AP) multi-link device (MLD) arranged to roam among a plurality of AP MLDs of a roaming AP MLD, the non-AP MLD comprising circuitry to receive from the roaming AP MLD an announcement, the announcement indicating that the roaming AP supports one of a link level roaming and MLD roaming within the roaming AP MLD, wherein the link level roaming comprises terminating less than all links from the non-AP MLD to respective AP MLD of the roaming AP MLD and establishing a new link from the non-AP MLD to an AP MLD of the roaming AP MLD different from an AP MLD associated with the one or more terminated links and the MLD roaming comprises terminating all links from the non-AP MLD to a first AP MLD of the roaming AP MLD and establishing at least one new link from the non-AP MLD to a second AP MLD; send a roaming request to the roaming AP MLD, wherein the roaming request indicates one of the link level roaming and MLD roaming based on the announcement; receive a roaming response from the roaming AP MLD, the response indicating the at least one new link established from the non-AP MLD to the roaming AP MLD; and exchange one or more frames between the non-AP MLD and the roaming AP MLD based on the at least one new link established from the non-AP MLD to the roaming AP MLD.

15. The non-AP MLD of claim 14, wherein the roaming response indicates a time when the non-AP MLD is able to exchange frames with the roaming AP MLD via the at least one new links.

16. The non-AP MLD of claim 14, wherein the non-AP MLD is arranged with circuity to not use the at least one new link to the roaming AP MLD to transmit uplink frames to the roaming AP MLD until the roaming response is received and receive downlink frames from the roaming AP MLD using the at least one new link until the roaming response is received.

17. The non-AP MLD of claim 14, wherein the announcement indicates whether the roaming AP MLD supports one TID being mapped to links from the non-AP STA to two AP affiliated with different AP MLDs of the roaming AP MLD.

18. The non-AP MLD of claim 14, wherein the circuity arranged to exchange one or more frames comprises circuity for exchanging class 3 frames defined by IEEE 802.11 when links from the non-AP MLD to the roaming AP MLD change from links to two AP MLD of the roaming AP MLD to links to only one AP MLD of the roaming AP MLD.

19. The non-AP MLD of claim 14, wherein the non-AP MLD is arranged to use a link with a current serving AP MLD until the non-AP MLD completes a frame exchange context in the new link with a new serving AP MLD, the non-AP MLD using the new link with the new serving AP MLD to transmit uplink frames when the frame exchange context is completed and receiving downlink frames from the current serving AP MLD and the new serving AP MLD.

20. The non-AP MLD of claim 19, wherein the frame exchange context includes one or more of a pairwise master key (PTK), pairwise transient key (PTK) context of the non-AP MLD, and an unassigned sequence number (SN) for downlink traffic.

21. An access point (AP) multi-link device (MLD) of a roaming AP MLD which comprises a plurality of AP MLD, the AP MLD comprising circuitry to transmit an announcement to a non-AP MLD roaming among the plurality of AP MLD, the announcement indicating that the roaming AP supports one of a link level roaming and MLD roaming within the roaming AP MLD, wherein the link level roaming comprises terminating less than all links from the non-AP MLD to respective AP MLD of the roaming AP MLD and establishing a new link from the non-AP MLD to an AP MLD of the roaming AP MLD different from an AP MLD associated with the one or more terminated links and the MLD roaming comprises terminating all links from the non-AP MLD to a first AP MLD of the roaming AP MLD and establishing at least one new link from the non-AP MLD to a second AP MLD; receive a roaming request to the roaming AP MLD, wherein the roaming request indicates one of the link level roaming and MLD roaming based on the announcement; send a roaming response to the non-AP MLD, the response indicating the at least one new link established from the non-AP MLD to the roaming AP MLD; and exchange one or more frames between the non-AP MLD and the roaming AP MLD based on the at least one new link established from the non-AP MLD to the roaming AP MLD.

22. The AP MLD of claim 17, wherein one AP of the AP MLD of the roaming AP MLD which serves the non-AP MLD inherits a per STA profile of the non-AP MLD from another AP MLD of the roaming AP MLD.

23. The AP MLD of claim 17, further comprising circuitry to terminate a link from the non-AP MLD to the AP MLD or establish a link from the non-AP MLD to the AP MLD in response to the request.

24. The AP MLD of claim 17, wherein the circuitry to send the roaming response comprises circuitry to send the roaming response based on a time indicated in the roaming request when the non-AP MLD is able to exchange frames with the roaming AP MLD via the at least one new link.
